(19) United States
(12) Patent Application Publication
(10) Pub. No.: US 2016/0171418 A1
(43) Pub. Date: Jun. 16, 2016

(54) LEAD ALLOCATION BASED ON LEAD ATTRIBUTES

(71) Applicant: ZipRealty LLC, Emeryville, CA (US)

(72) Inventors: James Wilson, Emeryville, CA (US); Colin McConnell, Emeryville, CA (US)

(21) Appl. No.: 14/565,702

(22) Filed: Dec. 10, 2014

(51) Int. Cl. G06Q 10/06; G06Q 50/16

(52) U.S. Cl. CPC G06Q 10/063112; G06Q 50/16

(57) ABSTRACT

A system comprising a computer-readable storage medium storing at least one program and a computer-implemented method for lead allocation are presented. Consistent with some embodiments, the method may include determining at least one attribute of a lead, and identifying a real estate agent with expertise in conversion of leads having the at least one attribute. The method may then include allocating the lead to the real estate agent based on such expertise.

### TECHNICAL FIELD

This application relates generally to data processing within a network-based system and, more specifically, to a lead allocation system for a real estate service.

### BACKGROUND

Currently, a vast amount of real estate transactions are performed online. For example, real estate agents may take advantage of network-based real estate services to perform tasks such as drafting and transmitting offers for purchases of properties. Consumers, on the other hand, may be able to utilize other network-based real estate services to search through online property listings or schedule tours with real estate agents. Current technologies are, however, limited in functionality and are deficient in many aspects that affect both consumers and real estate agents.

For example, consumers interested in purchasing property, referred to as “leads,” may be assigned or otherwise allocated to a real estate agent with an intention that the real estate agent build a relationship with the lead so that the lead may eventually purchase property using the real estate agent. Current technologies aim to match leads with real estate agents that are well suited to guide the leads to a purchase of property. Traditionally, real estate agents are matched with leads based on attributes of the properties (e.g., location) the leads wish to purchase. For example, a particular lead interested in purchasing a two-bedroom house may be assigned to an agent based on the agent's transactional experience with two-bedroom houses. However, these technologies often ignore characteristics of the leads themselves, which may result in failed conversion of the lead because although the real estate agent may have experience with certain types of homes, the real estate agent may not have actual experience in dealing with idiosyncrasies of certain types of leads.

### BRIEF DESCRIPTION OF THE DRAWINGS

Various ones of the appended drawings merely illustrate example embodiments of the present invention and cannot be considered as limiting its scope.

FIG. 1 is a block diagram illustrating an abstract view of various functional components of a real estate marketing platform, according to an example embodiment.

FIG. 2 is a block diagram illustrating an architectural view of the real estate marketing platform, according to an alternative embodiment, having a client-server architecture configured for exchanging data over a network.

FIG. 3 is a high-level entity-relationship diagram, illustrating various tables that may be maintained within a database of the real estate marketing platform, according to an example embodiment.

FIG. 4 is a block diagram illustrating various functional modules of a lead allocation application, which is provided as part of the real estate marketing platform, consistent with some embodiments.

FIG. 5 is a flowchart illustrating a method for allocating a real estate sales lead in a real estate marketing platform, according to an example embodiment.

FIG. 6 is a flowchart illustrating a method for allocating a real estate sales lead based on lead source, according to an example embodiment.

FIG. 7 is a flowchart illustrating a method for allocating a real estate sales lead based on engagement with a real estate marketing platform, according to an example embodiment.

FIG. 8 is a flowchart illustrating a method for determining expertise of a real estate agent in conversion of leads with particular attributes, according to an example embodiment.

FIG. 9 is a flowchart illustrating a method for calculating an engagement score of a consumer of the real estate marketing platform, according to an example embodiment.

FIG. 10 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the scope of the disclosure. Further, embodiments may be practiced without some or all of these specific details.

Aspects of the present disclosure relate to lead allocation in a network-based real estate marketing platform. Example embodiments involve a real estate marketing platform that provides various real estate marketing services to both consumer users (also referred to herein as “consumers”) and real estate agent users (also referred to herein as “real estate agents” or simply “agents”). For purposes of this specification, a “lead” refers to an individual or entity with interest in conducting a property transaction (e.g., buying or selling property). In example embodiments, leads are those individuals or entities with specific interest in real estate property transactions, although the inventive subject matter described herein is not limited to real estate property. For purposes of the present disclosure and the claims, the term “real estate property” refers to any house or structure and the land on which it sits or a piece of undeveloped land including any natural resources (e.g. crops, minerals, or water) located on the land.

In contrast to a lead, a “client” refers to an individual or entity engaged (even preliminarily) in a real estate property transaction. A client may be further classified based on the client's progress in the real estate transaction process. For example, a “pre-listing client” is a client that has a pending listing appointment; a “showing client” is a client that has scheduled a visit to tour a property; an “offering client” is a client who has made an offer that has not yet been accepted; a “listing client” is a client that has a real estate property listing; a “transacting client” is a client that has a pending transaction; and a “closed client” is a client that has a completed transaction (referred to as a “closed transaction”).

The process of converting a lead to a client is referred to as “lead conversion,” “converting a lead,” or simply “conversion.” Example embodiments involve matching leads, with a real estate marketing platform, to a real estate agent that is most capable of converting the lead. To accomplish this matching, an example method may be employed to determine characteristics of each lead and identify real estate agents with expertise in converting prior leads with similar characteristics. The method may further include allocating each lead to a real estate agent that has at least a threshold level of expertise in converting similar leads (e.g., the agent has closed a certain number of transactions involving leads with similar characteristics).

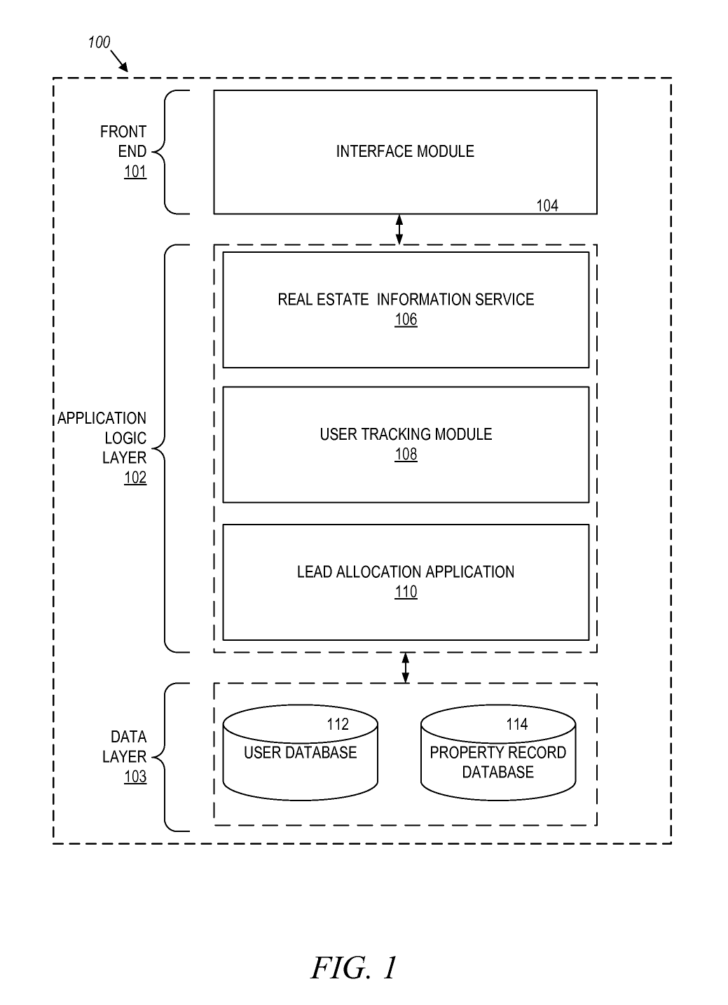

FIG. 1 is a block diagram illustrating an abstract view of various functional components of a real estate marketing platform 100, according to an example embodiment. It will be appreciated that although the functional components of the real estate marketing platform 100 are discussed in the singular sense, multiple instances of each component may be employed. The real estate marketing platform 100 may correspond to a real estate website (e.g., www.ziprealty.com) and may provide various real estate marketing services to both consumer users and real estate agent users. As shown in FIG. 1, the real estate marketing platform 100 is generally based on a three-tiered architecture, comprising a front-end layer 101, application logic layer 102, and a data layer 103. As is understood by those skilled in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules, applications, and engines that are not germane to conveying an understanding of the inventive subject matter have been omitted from FIG. 1. However, various additional functional modules, applications, and engines may be used with the real estate marketing platform 100 to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer 101 includes an interface module 104 (e.g., a web server and application program interface (API)), which receives requests from various client-computing devices of various users, and communicates appropriate responses to the requesting client devices that may include instructions to cause the presentation of any one of the interfaces discussed herein. For example, the interface module 104 may receive requests in the form of Hypertext Transport Protocol (HTTP) requests or other web-based, API requests. The interface module 104 may include an API module, which is coupled to and provides programmatic interfaces to the application logic layer 102. In this way, the API module of the interface module 104 may enable third-party applications to invoke the functionality of the real estate marketing platform 100.

The application logic layer 102 of the real estate marketing platform 100 may include at least one server that includes at least one processing device configured to implement the respective methods discussed herein. As illustrated by FIG. 1, the real estate marketing platform 100 may include a real estate information service 106, a user tracking module 108, and a lead allocation application 110. The real estate information service 106 may host information for real estate properties and may maintain several listings of properties for sale. Each property listing may have a dedicated web page (or a set of web pages) to provide information for each property. This information may include pictures, floor plans, and a geographic area in which the property is located along with other attributes of the property (e.g., price, size, year built, date listed, price per square foot, number of bedrooms, number of bathrooms, and property type). Online property listings may also provide a consumer with an ability to print the listing, save the listing for later viewing, share the listings with another user, request a visit to the property, request more information about the property, and get directions to the property.

The real estate information service 106 may provide consumers with the ability to quickly filter, sort, and search through property listings using one or more search parameters. For example, the real estate information service 106 may enable a consumer to perform a search query for properties within a particular geographic area. As referenced above, the geographic area in which the property is located may be maintained on each property listing page. A geographic area search may, for example, limit the search to property within a particular city, neighborhood, subdivision, postal code, or school district. As another example, the real estate information service 106 may enable a user to perform a search query for properties with certain attributes, which are maintained as part of the corresponding property listing. Attributes of a property may, by way of non-limiting example, include a property type (e.g., single family house, multi-family house, condo, land, or apartment), a size (e.g., square footage), a number of bedrooms, a number of bathrooms, an exact price, a price range, a price decile (e.g., “third decile in market”), a year built, a date listed, a number of days on the market, or a transaction type (e.g., foreclosure, short sale, new construction, tenancy in common, or fixer upper).

The user tracking module 108 may be a hardware implemented module or software executed by general purpose or special purpose hardware or instructions stored on a computer readable medium that is operative to track the activity of users (both consumers and agents) with respect to the real estate marketing platform 100. The user tracking module 108 may store the respective activities of the consumer and agent users as consumer and agent activity data, respectively (e.g., in database 112).

The user tracking module 108 may track several types of consumer user activity, which are referenced above with respect to the functionalities of the real estate information service 106. The user tracking module 108 may track consumer user activity for each consumer user of the real estate marketing platform 100 with respect to the functionalities discussed herein. Before being able to engage in certain activities with the real estate information service 106, a consumer user may be prompted to set up a user account. Consistent with some embodiments, the consumer activity data may be maintained as part of such a user account maintained by the real estate marketing platform 100.

Consumer user activity may, for example, include the following actions: setting up an account, subscribing to alerts or notifications, logging on to an account (e.g., via mobile application or web client), viewing an agent profile page, viewing agent ratings, performing a property search query using location or attribute parameters, saving a property search, viewing an online web page for a property listing, printing a property listing, saving a listing for later viewing, sharing a listing with another user (e.g., via email or social network), requesting or scheduling a visit to a property, requesting more information about a property, requesting directions to a property, performing a geopositional property search query, performing an image-recognition based property search query, or any other actions a consumer user may take on the real estate information service 106.

The user tracking module 108 may also track and record agent user activity for each agent user of the real estate marketing platform 100 with respect to the functionalities discussed herein. The agent user activity may, for example, include logging into an account provided by the real estate marketing platform 100, enabling notifications from the real estate marketing platform 100, communicating with or otherwise contacting consumer users using tools provided by the real estate marketing platform 100, and other actions related to utilization of the various services provided by the real estate marketing platform 100.

The lead allocation application 110 is responsible for allocating leads (e.g., a consumer or other individual interested in purchasing property) to real estate agents. The lead allocation application 110 may allocate a lead to the real estate agent who may be most capable or best suited (e.g., most experienced) to convert the lead to a client. To this end, the lead allocation application 110 may determine attributes of an lead, and allocate the lead to a particular real estate agent based on the real estate agent's experience in converting leads with those attributes (e.g., closing transactions involving leads with those attributes).

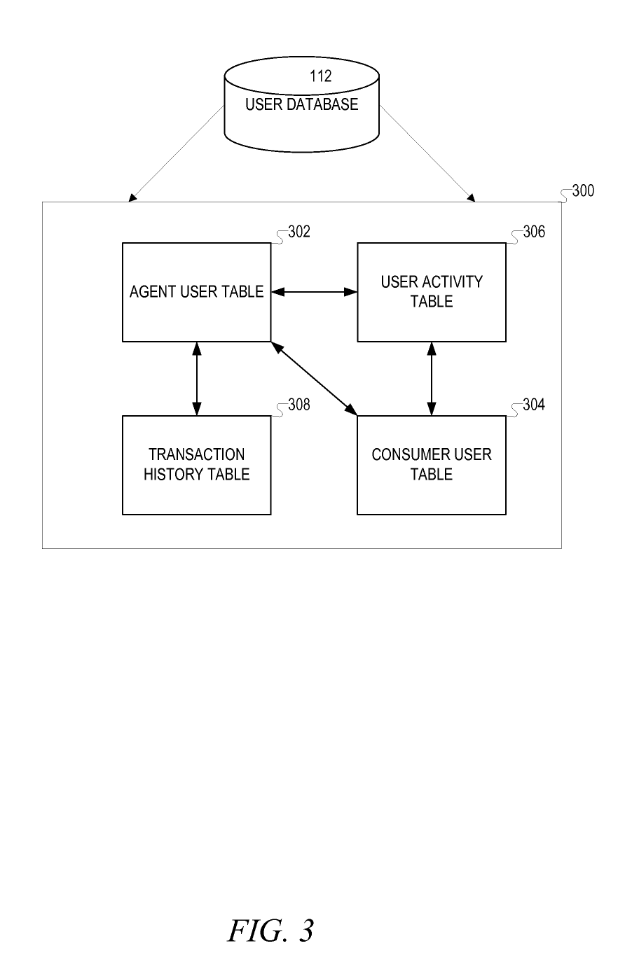

As illustrated in FIG. 1, the application logic layer 102 may be communicatively coupled to the data layer 103. The data layer 103 may include multiple databases, including databases 112 and 114. The user database 112 may store user data including consumer and agent user activity information tracked and recorded by the user tracking module 108. Examples of tables stored in the user database 112 will be discussed in greater detail below in reference to FIG. 3.

The property record database 114 may store a record for one or more properties maintained by the real estate information service 106. Each record may include an identifier, an address, and other information pertaining to one or more real estate properties. This information may be maintained for properties that are currently on the market and listed by the real estate information service 106 or by a third party server (not shown). The property record database 114 may also include information for other properties that are not currently listed by a listing service and/or are not on the market. The information maintained for each property may include geographic area location information. Geographic area information may, for example, include a state, a city, a postal code, a neighborhood, a county, a school district, or a metropolitan area.

The property record database 114 may also include specific attributes of each property including, for example, a property type (e.g., single family house, multi-family house, condo, land, or apartment), a property size (e.g., square footage), a number of bedrooms, a number of bathrooms, a price, a year built, a date listed, a number of days on the market, and a transaction type (e.g., new, resale, standard, foreclosure, short sale, tenancy in common, or fixer upper).

In one embodiment, property record information for a particular property stored in the property record databases 114 may be obtained from a user through the interface module 104. In another embodiment, property record information for a particular property stored in the property record databases 114 may be obtained via the API module from public and private (e.g., multiple listing service (MLS)) property listing databases.

While the real estate information service 106 and lead allocation application 110 are shown in FIG. 1 to form part of the real estate marketing platform 100, it will be appreciated that, in alternative embodiments, either of the real estate information service 106 or the lead allocation application 110 may form part of or operate in conjunction with a service that is separate and distinct from the real estate marketing platform 100. The various functional components of the application logic layer 102 may also be implemented as standalone systems or software programs, which do not necessarily have networking capabilities. It shall be appreciated that although the various functional components of the real estate marketing platform 100 are discussed in the singular sense, multiple instances of one or more of the various functional components may be employed.

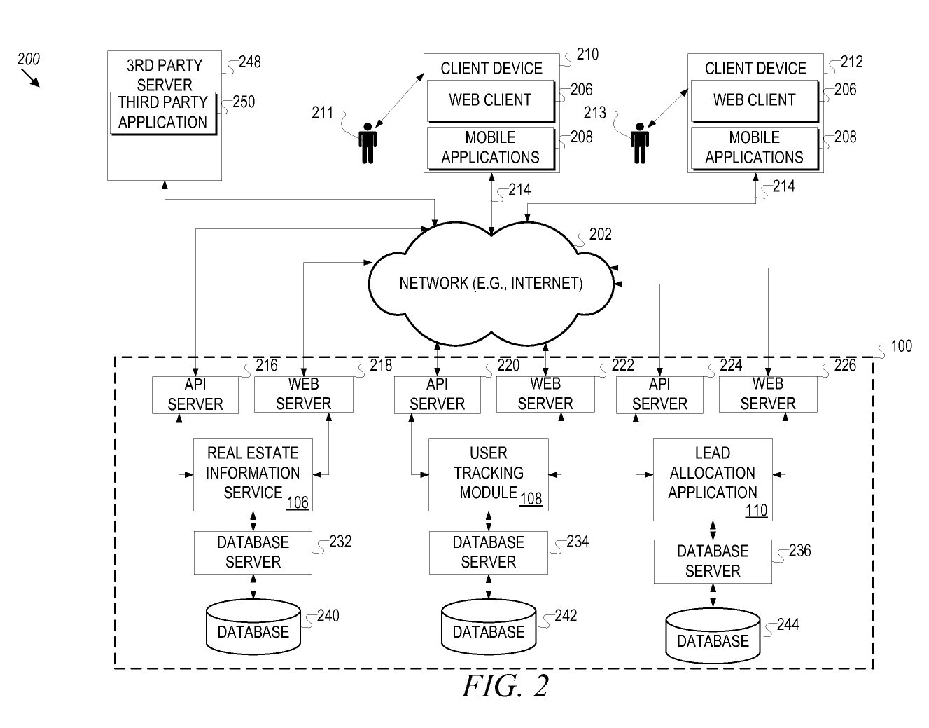

FIG. 2 is a block diagram illustrating an architectural view of the real estate marketing platform 100, according to an alternative embodiment, having a client-server architecture configured for exchanging data over a network. It will be appreciated that although the components of the real estate marketing platform 100 are discussed in the singular sense, multiple instances of each component may be employed. The real estate marketing platform 100 provides server-side functionality, via a network 202 (e.g., the Internet or wide area network (WAN)), for each real estate information service 106, and lead allocation application 110 to one or more clients. For example, FIG. 2 illustrates client devices 210 and 212 that represent example devices that can be utilized by users to perform various activities associated with the real estate marketing platform 100. The client devices 210 and 212 may be any of a variety of types of devices such as a personal computer, a laptop computer, a cellular telephone, a personal digital assistant (PDA), a personal navigation device (PND), a handheld computer, a tablet computer, a notebook computer, or other type of movable device. As illustrated, the first client device 210 is used by an agent 211, while the second client device 212 is used by a consumer 213.

The client devices 210 and 212 may be executing conventional web browser applications (e.g., web client 206), or mobile applications 208 that have been developed for a specific platform to include any of a wide variety of mobile devices and operating systems. For example, the client devices 210 and 212 may be executing a mobile application 208 specifically developed for interacting with the real estate marketing platform 100. The mobile application 208 may provide enhanced search functionality to the consumer 213. For example, the real estate information service 106 may utilize the Global Positioning System (GPS) functionality of the client device 212 to provide the consumer 213 with the ability to perform a geopositional property search query. A geopositional property search query may allow the consumer 213 to perform a property search query for property listings within a specified distance from a location of the consumer 213.

The mobile application 208 may further utilize a camera (e.g., included in the client device 210 or 212) combined with existing image-recognition and geopositioning techniques to provide the consumer 213 with an image-recognition based property search query. An image-recognition based property search query may identify a property from an image and provide the consumer 213 with the corresponding online property listing. For example, the real estate information service 106 may receive an image of a particular property from the client device 212, and based on the recognition of the particular property, the real estate information service 106 may provide the consumer 213 with the corresponding property listing for the particular property. In another example, the real estate information service 106 may receive an image from the client device 212 of a real estate sign associated with a particular property having a unique identifier (e.g., quick response (QR) code or bar code) identifying the particular property. In this example, the real estate information service 106 may provide the client device 212 with the property listing corresponding to the property based on recognition of the unique identifier.

The client devices 210 and 212 may interface via a connection 214 with a communication network 202. Depending on the form of the client devices 210 and 212, any of a variety of types of connections 214 and communication networks 202 may be used. For example, the connection 214 may be a Code Division Multiple Access (CDMA) connection, a Global System for Mobile communications (GSM) connection, or other type of cellular connection. The connection 214 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 202 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or to other types of networks).

In another example, the connection 214 may be Wireless Fidelity (Wi-Fi, IEEE 802.11x type) connection, a Worldwide Interoperability for Microwave Access (WiMAX) connection, or another type of wireless data connection. In such an embodiment, the communication network 202 may include one or more wireless access points coupled to a local area network (LAN), a wide area network (WAN), the Internet, or other packet-switched data network. In yet another example, the connection 214 may be a wired connection, for example an Ethernet link, and the communication network 202 may be a LAN, a WAN, the Internet, or other packet-switched data network. Accordingly, a variety of different configurations are expressly contemplated.

Each of the API servers 216, 220, and 224, and each of the web servers 218, 222, and 226 are coupled to, and provide programmatic and web interfaces to, the real estate information service 106, user tracking module 108, and lead allocation application 110, respectively. The real estate information service 106, user tracking module 108, and lead allocation application 110, are, in turn, shown to be respectively coupled to databases servers 232, 234, and 236 that facilitate access to databases 240, 242, and 244, respectively. The databases 240, 242, and 244, may correspond to the databases 112 and 114.

As illustrated by FIG. 2, the web client 206 accesses functionality of the real estate marketing platform 100 via the web interface supported by each of the web servers 218, 222, and 226, respectively. Similarly, the mobile applications 208 access the various services and functions provided by the real estate marketing 100 via the programmatic interface provided by the API servers 216, 220, and 224.

FIG. 2 also illustrates a third party server 248 having programmatic access to the real estate marketing platform 100 via the communication network 202. The third party server 248 may be coupled via a server to the communication network 202, for example, via wired or wireless interfaces. The third party server 248 may, utilizing information retrieved from the communication network 202, support one or more third party applications 250. The third party application 250 may be a website hosted by the third party that supports or utilizes one or more functions or features of the real estate marketing platform 100.

Each of the real estate information service 106, user tracking module 108, and lead allocation application 110 may provide a number of functions and services, as discussed herein, to users that may access each individually. While the real estate information service 106, user tracking module 108, and lead allocation application 110 are shown in FIG. 2 to be separate and distinct modules, it will be appreciated that, in alternative embodiments, that the real estate information service 106, user tracking module 108, and lead allocation application 110 may form one integrated networked system, such as the system illustrated by FIG. 1. Further, while the system 200 shown in FIG. 2 employs a client-server architecture, the present invention is, of course, not limited to such an architecture, and could equally well find application in a distributed, event-driven, or peer-to-peer architecture system, for example. The real estate information service 106, user tracking module 108, and lead allocation application 110 could also be implemented as standalone software programs, which do not necessarily have networking capabilities.

FIG. 3 is a high-level entity-relationship diagram, illustrating various tables 300 that may be maintained within the user databases 112. In particular, the tables 300 may include an agent user table 302, a consumer user table 304, a user activity table 306, and a transaction history table 308. The agent user table 302 contains a record for each real estate agent user of the real estate marketing platform 100, and may include an identifier of the agent such as a name, a username, an email address, a realtor license number, or some other unique numerical identifier. The consumer user table 304 contains a record for each consumer user that has interacted with the real estate marketing platform 100. The consumer user table 304 may include an identifier for each user such as a name, a username, an email address, or unique numerical identifier. The consumer user table 304 may further include at least one consumer classification for each user. The consumer classifications may, for example, include a closed client, a transacting client, an offering client, a listing client, a showing client, a pre-listing client, a responsive prospect, an unresponsive prospect, a cold prospect, a reassigned lead, or a new lead. At least a portion of the consumer users for which a record is maintained in the consumer user table 304 may be linked to one or more records of the agent user table 302, so as to associate a consumer with an assigned agent, and maintain a record of historical lead assignments.

The user activity table 306 maintains a record of user activity for users (e.g., consumers and agents) of the real estate marketing platform 100. In some embodiments, the user activity table 306 stores a historical record of consumer user activity for each consumer user that has interacted with the real estate marketing platform 100. The consumer user activity includes actions performed by consumers while utilizing the real estate marketing platform 100. The user activity table 306 may include an aggregate value for the number of times certain actions are performed. For example, the user activity table 306 may include a total number of times a particular property attribute was used as a parameter in a property search query, a total number of times a particular geographic area was used as a parameter in a property search query, a total number of page views of an online web page for a property listing, a total number of times a property listing was printed, a total number of times a property listing was saved for later viewing, a total number of times a property listing was shared with another user, a total number of requests to view a property, a total number of requests for more information about a property, or a total number of requests for directions to a property.

In some embodiments, the user activity table 306 stores historical records of agent user activity for agent users of the real estate marketing platform 100. The agent user activity includes actions performed by real estate agents while using the real estate marketing platform 100. The records may include an identifier of each action performed as well as an indication of the timing of performance of the action. The user activity table 306 may maintain an aggregate value for the number of times certain actions are performed as well as a record of elapsed time between performance of certain actions (e.g., time taken to respond to a message from a consumer). Entries in the user activity table 306 may be linked to one or more records of the consumer user table 304 and the agent user table 302, so as to provide a record of user activity for each user (consumers and agents) of the real estate marketing platform 100.

The transaction history table 308 stores a historical record of real estate transaction involving agents of the real estate marketing platform 100. Entries within the transaction history table 308 may include a property identifier (e.g., an address), a closing price, property attributes, and other information pertinent to real estate transactions. The involvement by the real estate agents may be in the purchasing or selling of the property. Entries in the transaction history table 308 may be linked to one or more entries in the agent user table 302 so as to maintain a transactional history for each agent user of the real estate marketing platform 100. Entries in the transaction history table 308 may be further linked to one or more entries in the consumer user table 304 so as to maintain a record of consumers (e.g., clients) involved in each transaction.

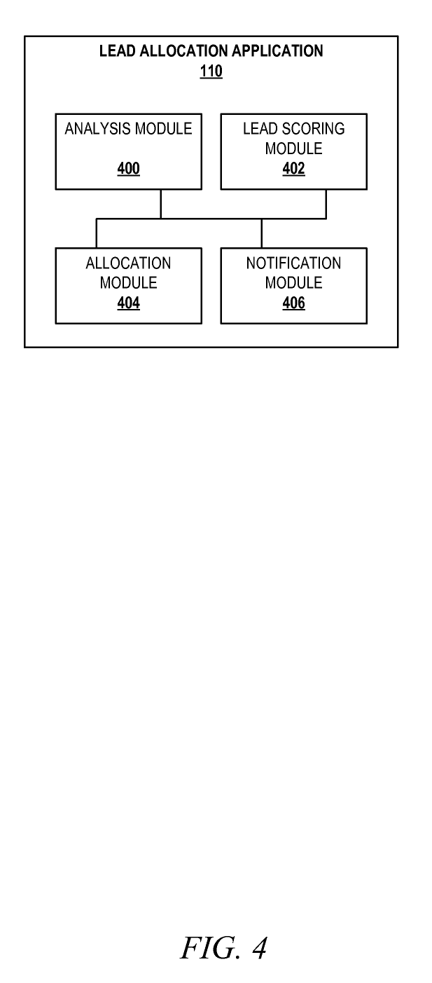

FIG. 4 is a block diagram illustrating various functional modules of the lead allocation application 110, which is provided as part of the real estate marketing platform 100, consistent with some embodiments. The lead allocation application 110 is illustrated to include an analysis module 400, a lead scoring module 402, an allocation module 404, and a notification module 406, all configured to communicate with each other (e.g., via a bus, shared memory, a switch, or application programming interfaces (APIs)). The various modules of the lead allocation application 110 may, furthermore, access the databases 112 and 114, and each of the various modules of the lead allocation application 110 may be in communication with one or more of the third party applications 250. Further, while the modules of FIG. 4 are discussed in the singular sense, it will be appreciated that, in other embodiments, multiple modules may be employed.

The analysis module 400 may be a hardware implemented module or software executed by general purpose or special purpose hardware or instructions stored on a computer readable medium that is operative to analyze information about new and reassigned leads to determine lead attributes. Lead attributes relate to characteristics of a lead (e.g., a person), which may be distinguished from property attributes that are related to characteristics of a property. The leads of the real estate marketing platform 100 (new and reassigned) may be either paid or unpaid (also referred to as “organic”) leads. Paid leads may originate from a variety of lead generation services and other sources such as Google®, Bing®, BoomTown®, or other third party affiliates. Unpaid leads may, for example, arrive at the real estate marketing platform 100 as a result of a search query.

The analysis module 400 may determine both primary and secondary lead attributes. Primary lead attributes refer to characteristics of the individuals (e.g. leads) with interest in engaging in a property transaction (e.g., buying or selling). In example embodiments, the analysis module 400 determines primary lead attributes related to lead type (e.g., paid or unpaid) and user status (e.g., new or returning) with respect to the real estate marketing platform 100. Secondary lead attributes refer to characteristics of the individual that provide further information about a primary lead attribute. For example, for leads that are returning users of the real estate marketing platform 100, the analysis module 400 may determine a responsiveness level (a secondary lead attribute) for the leads based on user activity data stored in user database 112. The secondary lead attributes determined by the analysis module 400 may also include a lead source (e.g., lead generation service or search query) and lead engagement level (e.g., as represented by an engagement score). For lead sources such as search queries, the analysis module 400 may further analyze the search queries of such organic leads to determine additional secondary lead attributes of the leads, consistent with some embodiments.

The lead scoring module 402 may be a hardware implemented module or software executed by general purpose or special purpose hardware or instructions stored on a computer readable medium that is operative to determine engagement level of leads who are existing users of the real estate marketing platform 100. As part of this process, the lead scoring module 402 may calculate an engagement score for each lead based on corresponding user activity (e.g., stored in a record in the database 112) of the lead. The engagement score provides a measure of how active a consumer is on the real estate networked information system, and thus, the engagement score may indicate the likelihood of the consumer making a real estate purchase. In determining the engagement score, the lead scoring module 402 may assign a first weight to each user action based on the relative level of engagement of the action. The lead scoring module 402 may apply further weighting based on the timing of the action. The lead scoring module 402 may use an aggregation of the weighted values calculated for each action to determine the engagement score of the consumer.

The allocation module 404 may be a hardware implemented module or software executed by general purpose or special purpose hardware or instructions stored on a computer readable medium that is operative to allocate and assign leads to real estate agents. In example embodiments, the allocation module 404 may allocate a lead to a particular real estate agents based on the agent's expertise in converting similar leads to clients of the real estate marketing platform 100. Accordingly, the allocation module 404 may be configured to identify real estate agents with expertise in converting leads with particular attributes. The expertise of the real estate agent may be determined by accessing historical transaction data (e.g., stored in database 114) of a plurality of real estate agents (e.g., real estate agents serving a particular geographic location), and identifying real estate agents with a threshold number of transactions involving clients who were previously leads with a particular attribute or set of attributes. For example, the allocation module 404 may determine a real estate agent has expertise in organic leads originating from search queries based on the real estate agent closing ten transactions with organic leads that originated from search queries.

The notification module 406 may be a hardware implemented module or software executed by general purpose or special purpose hardware or instructions stored on a computer readable medium that is operative to provide notifications to users (consumers and agents) of the real estate marketing platform 100. Notifications provided by the notification module 406 may relate to actions of other users on the real estate marketing platform 100. For example, the notification module 406 may notify an agent user when a consumer user views the agent profile of the agent user. In another example, the notification module 406 may notify an agent of a newly allocated lead.

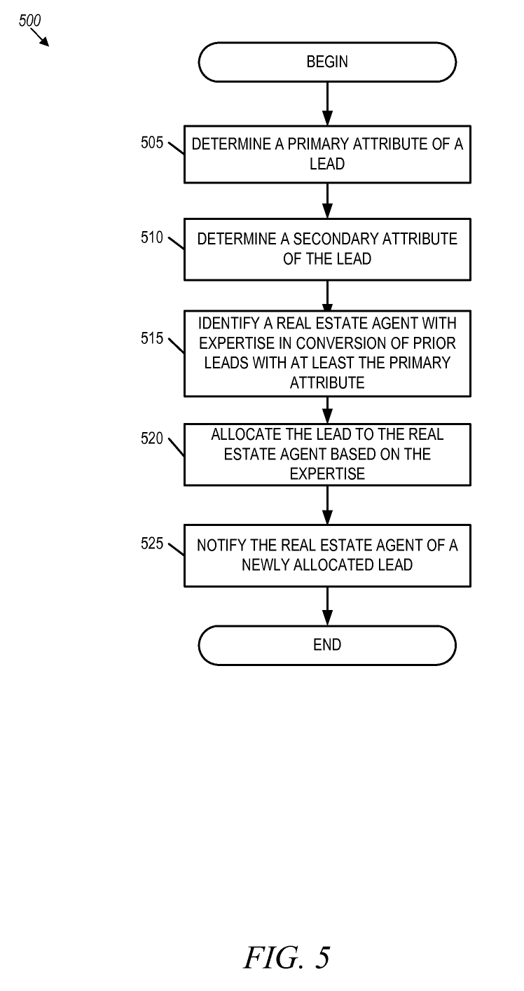

FIG. 5 is a flowchart illustrating a method 500 for allocating an incoming real estate lead in the real estate marketing platform 100, according to an example embodiment. The method 500 may be embodied in computer-readable instructions for execution by one or more processors such that the steps of the method 500 may be performed in part or in whole by the lead allocation application 110. In particular, the method 500 may be carried out by the modules forming the lead allocation application 110, and accordingly, the method 500 is described below by way of example with reference thereto. However, it shall be appreciated that the method 500 may be deployed on various other hardware configurations and is not intended to be limited to the modules of the lead allocation application 110.

In example embodiments, the method 500 may be initiated in response to obtaining a new lead. The new lead may be obtained from a lead generation service, or organically from a source such as a search query. In some instances, the lead may be a returning unregistered or registered consumer user of the real estate marketing platform 100. In these instances, the method 500 may be initiated in response to determining that the returning or registered consumer user has at least a predetermined threshold level of engagement (e.g., the engagement score of the consumer user is above a certain threshold). In instances in which the lead is a new user to the real estate marketing platform 100, the method 500 may be initiated in response to receiving a request from the user for a real estate agent.

At operation 505, the analysis module 400 determines a primary attribute of a lead. The lead is an individual with interest in transacting property (e.g., real estate property), and the primary attribute of the lead is a characteristic of the individual. The primary attribute of the lead may, for example, be a lead type (e.g., paid or unpaid lead) or a user status (e.g., returning or new).

At operation 510, the analysis module 400 determines a secondary attribute (e.g., a lead source, level of engagement, or responsiveness) of the lead. The secondary attribute is a more specific characteristic of the individual that complements the primary attribute. For example, in instances in which the analysis module 400 determines that the user status (a primary attribute) of the lead is a returning user, the analysis module 400 may also determine a level of engagement (e.g., an engagement score) or responsiveness (responsive or unresponsive) of the returning user.

At operation 515, the allocation module 404 identifies a real estate agent with expertise in conversion of prior leads with at least the primary attribute of the lead. The identification of the real estate agent with expertise in conversion of such leads may be based on the total number of transactions closed by the agent that involve leads with at least the primary lead attribute. In some embodiments, the identification of the real estate agent with expertise in conversion of such leads may be based on the conversion rate of the real estate agent with respect to leads having at least the primary lead attribute.

In some instances, the allocation module 404 may identify a real estate agent with a more specific expertise in conversion of leads with at least a similar secondary attribute to that of the lead. For example, if the analysis module 400 determines that the lead is an unresponsive returning user, the allocation module 404 may identify a real estate agent with expertise in conversion of unresponsive returning users. In another example, if the analysis module 400 determines that the lead is a paid lead from a particular lead generation service, the allocation module 404 may identify a real estate agent with expertise in conversion of paid leads from the particular lead generation service. In yet another example, if the analysis module 400 determines that the lead is an organic lead that arrived at the real estate marketing platform 100 by way of a particular search query, the allocation module 404 may identify a real estate agent with expertise in conversion of organic leads who arrived at the real estate marketing platform 100 by way of at least a similar (if not identical) search query.

At operation 520, the allocation module 404 allocates the lead to the identified real estate agent based on the real estate agent's expertise. In this way, the allocation module 404 allocates a lead to the real estate agent most likely to convert the lead into a client of the real estate marketing platform 100.

At operation 525, the notification module 406 notifies the real estate agent (e.g., transmits a notification or other message to the real estate agent) of the allocation of the lead. The notification may also provide the real estate agent with the ability to contact the lead either via telephone, text message, or email.

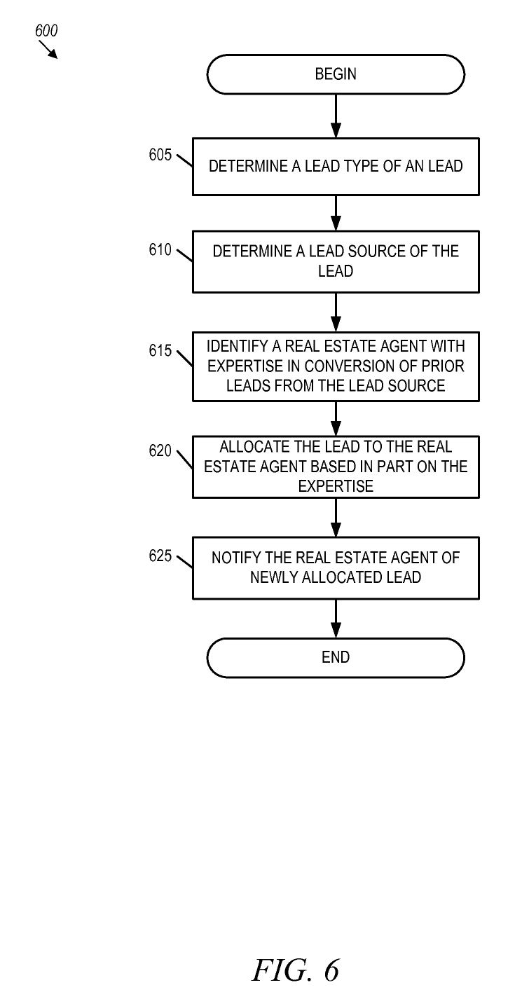

FIG. 6 is a flowchart illustrating a method 600 for allocating a real estate sales lead based on lead source, according to an example embodiment. The method 600 may be embodied in computer-readable instructions for execution by one or more processors such that the steps of the method 600 may be performed in part or in whole by the lead allocation application 110. In particular, the method 600 may be carried out by the modules forming the lead allocation application 110, and accordingly, the method 600 is described below by way of example with reference thereto. However, it shall be appreciated that the method 600 may be deployed on various other hardware configurations and is not intended to be limited to the modules of the lead allocation application 110.

At operation 605, the analysis module 400 determines a lead type of a lead (e.g., paid or unpaid lead). At operation 610, the analysis module 400 determines a lead source of the lead (e.g., a particular lead generation service or a search query). At operation 615, the allocation module 404 identifies a real estate agent with expertise in conversion of leads of the lead type and from the lead source. At operation 620, the allocation module 404 allocates the lead to the real estate agent based in part on their expertise. At operation 625, the notification module 406 notifies the real estate agent of the newly allocated lead. For example, the notification module 406 may cause a push notification to be transmitted to a client device of the real estate agent.

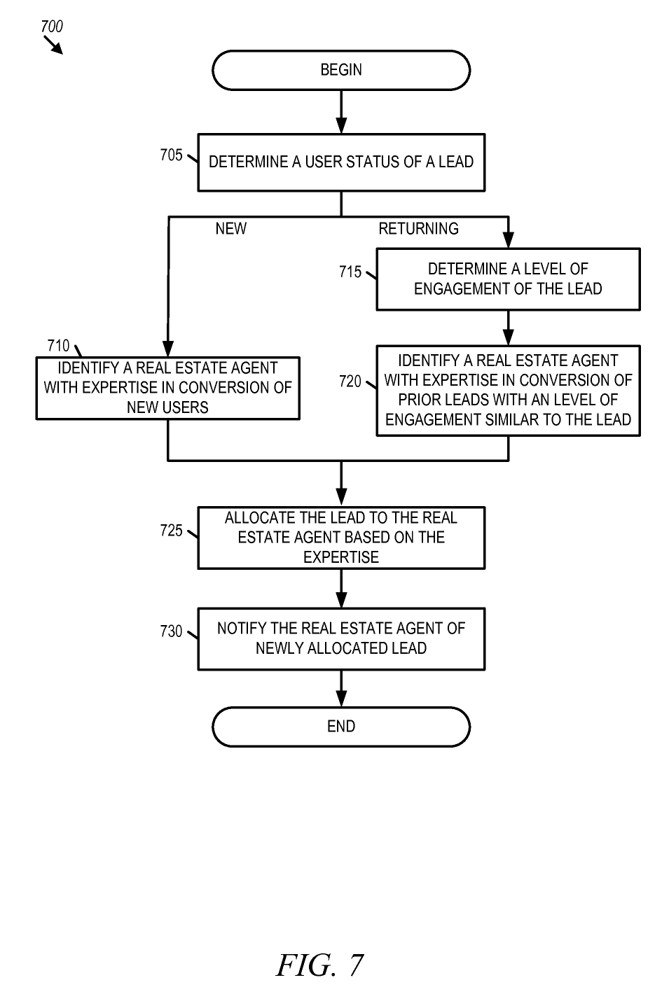

FIG. 7 is a flowchart illustrating a method for allocating a real estate sales lead based on engagement with a real estate marketing platform 100, according to an example embodiment. The method 700 may be embodied in computer-readable instructions for execution by one or more processors such that the steps of the method 700 may be performed in part or in whole by the lead allocation application 110. In particular, the method 700 may be carried out by the modules forming the lead allocation application 110, and accordingly, the method 700 is described below by way of example with reference thereto. However, it shall be appreciated that the method 700 may be deployed on various other hardware configurations and is not intended to be limited to the modules of the lead allocation application 110.

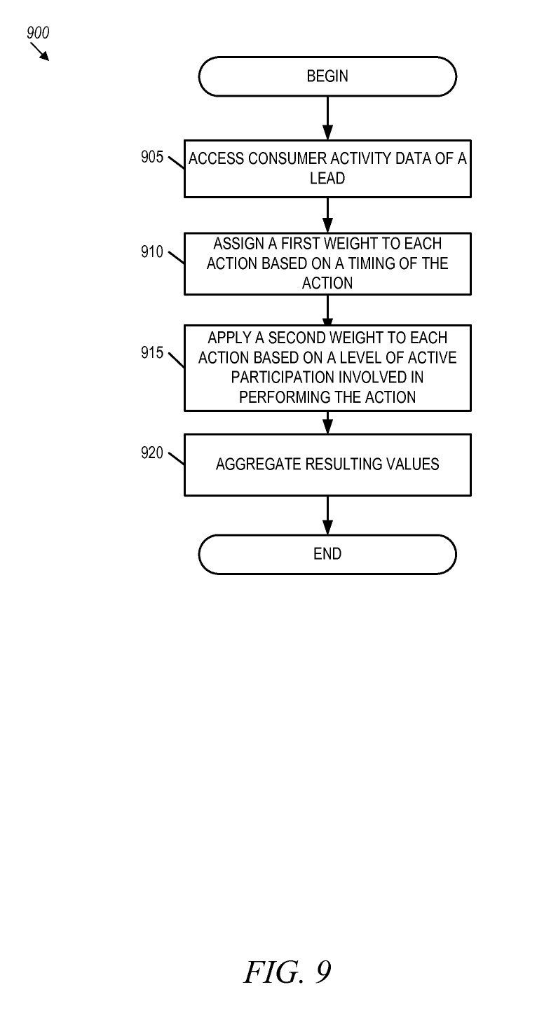

At operation 705, the analysis module 400 determines a user status of the lead. The user status may be either a new or a returning user. A returning user may be either registered (e.g., the user has signed up for an account with the real estate marketing platform 100) or unregistered. If the analysis module 400 determines the lead is a new user, the allocation module 404 identifies a real estate agent with expertise in conversion of new users, at operation 710. If the analysis module 400 determines the lead is a returning user, the lead scoring module 402 may determine a level of engagement (e.g., an engagement score) of the lead, at operation 715. Further details regarding the determination of the level of engagement are discussed below in reference to FIG. 9. At operation 720, the allocation module 404 may identify a real estate agent with expertise in conversion of leads with a similar level of engagement to the lead (e.g., an engagement score within a same range as the lead).

At operation 725, the allocation module 404 allocates the lead to the real estate agent based in part on the expertise identified at either operation 710 or 720. At operation 730, the notification module 406 notifies the real estate agent of the newly allocated lead. For example, the notification module 406 may cause a push notification to be transmitted to a client device of the real estate agent.

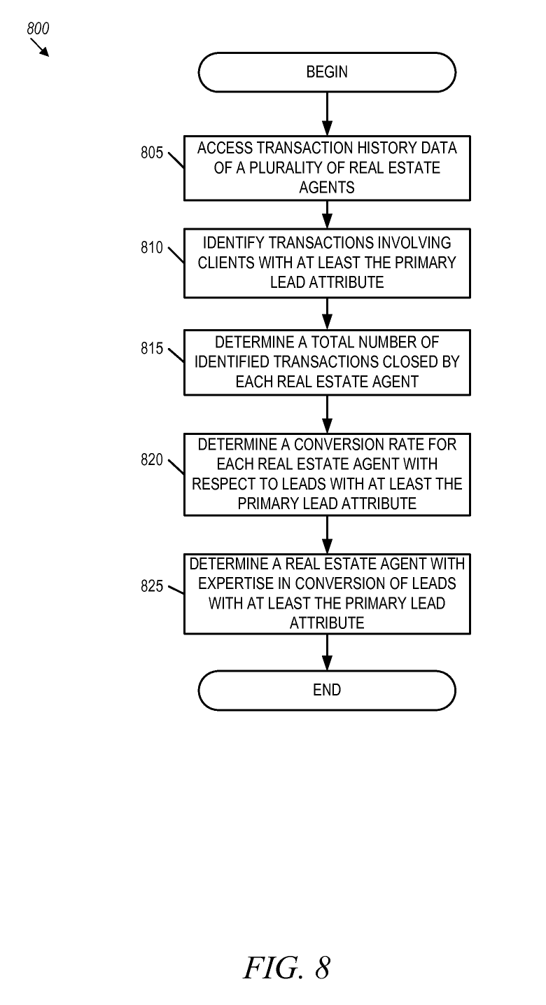

FIG. 8 is a flowchart illustrating a method 800 for determining expertise of a real estate agent in conversion of leads with particular attributes, according to an example embodiment. The method 800 may be embodied in computer-readable instructions for execution by one or more processors such that the steps of the method 800 may be performed in part or in whole by the lead allocation application 110. In particular, the method 800 may be carried out by the allocation module 404 of the lead allocation application 110, and accordingly, the method 800 is described below by way of example with reference thereto. However, it shall be appreciated that the method 800 may be deployed on various other hardware configurations and is not intended to be limited to the allocation module 404 or the lead allocation application 110.

At operation 805, the allocation module 404 accesses transaction history data of a plurality of real estate agents (e.g., stored in property record database 114). The transaction history data represents real estate transactions closed by the plurality of real estate agents. In some embodiments, the plurality of real estate agents corresponds to a group of real estate agents that serve a particular geographic area (e.g., the geographic area in which a lead may be interested in purchasing property). At operation 810, the allocation module 404 may identify transactions from the transaction history data that involve clients with at least the primary lead attribute of the lead. In some embodiments, the allocation module 404 may further identify transactions involving clients with the secondary lead attribute of the lead. At operation 815, the allocation module 404 determines a total number of identified transactions (e.g., transactions involving clients with at least the primary lead attribute) closed by each real estate agent of the plurality of real estate agents.

At operation 820, the allocation module 404 determines a conversion rate for each agent with respect to leads with at least the primary lead attribute. The “conversion rate” refers to the ratio of leads assigned to an agent 211 that have been converted to a client. The determination of the conversion rate may include assessing historical records of leads previously assigned to each real estate agent.

At operation 825, the allocation module 404 determines a real estate agent (from the plurality of real estate agents) with expertise in conversion of leads with at least the primary lead attribute. In some embodiments, the determination of such expertise may be based on the real estate agent's total number of transactions involving leads with at least the primary lead attribute being above a threshold number. In some embodiments, the determination of such expertise may be based on the conversion rate of the real estate agent with respect to leads with at least the primary lead attribute being above a threshold level. In some embodiments, the determination of expertise may be based on the real estate agent's total number of transactions involving leads with at least the primary lead attribute relative to the total number of such transactions involving the remainder of the plurality of real estate agents (e.g., a highest total number of the plurality of real estate agents). In some embodiments, the determination of expertise may be based on the real estate agent's conversion rate relative to the conversion rate of the remainder of the plurality of real estate agents (e.g., a highest conversion rate of the plurality of real estate agents).

FIG. 9 is a flowchart illustrating a method 900 for calculating an engagement score of a lead, according to an example embodiment. The method 900 may be embodied in computer-readable instructions for execution by one or more processors such that the steps of the method 900 may be performed in part or in whole by the lead allocation application 110. In particular, the method 900 may be carried out by the lead scoring module 402 of the lead allocation application 110, and accordingly, the method 900 is described below by way of example with reference thereto. However, it shall be appreciated that the method 900 may be deployed on various other hardware configurations and is not intended to be limited to the lead scoring module 402 or the lead allocation application 110.

At operation 905, the lead scoring module 402 may access consumer activity data of the lead (e.g., from the database 114) representative of activity (e.g., one or more actions) of the lead with respect to the real estate marketing platform 100. In some embodiments, the lead scoring module 402 may access a subset of the consumer activity data of the lead. The subset of consumer activity data may represent actions performed within a certain time period or may relate to specific types of actions such as actions for which the level of engagement is above a predefined threshold. For example, the lead scoring module 402 may access consumer activity data representative of the following actions: viewing an agent profile; viewing an agent's ratings; scheduling a showing; requesting more information; saving a property listing; viewing driving directions; sharing a property listing on a social network; logging into a mobile application; marking a property as a ‘favorite’; subscribing to e-mail alerts; saving a search; subscribing to alerts; printing a property listing; logging on to a user account provided by the real estate information service 106; or viewing a home detail page.

At operation 910, the lead scoring module 402 assigns a first weight to each action according to timing of the action. In this manner, each of the consumer's actions is weighted based on a recency of their performance. In an example, the lead scoring module 402 may assign actions performed within the previous six days with a value of 10, actions performed in the last seven to thirteen-days with a value of 8, actions performed in the last fourteen to twenty days with a value of 4, actions performed in the last twenty-one to twenty-seven days with a value of 2, and actions performed in the last twenty-eight to thirty days with a value of 1.

At operation 915, the lead scoring module 402 may, for each action, apply a second weight to each action. For example, the lead scoring module 402 may, for each action, multiply the first weight by the second weight. The result of the application of the second weight to the first weight is an overall weighting for each action that is based on a combination of recency and level of engagement. The second weight applied by the lead scoring module 402 is based on the level of engagement of each action. In this manner, each of the actions performed by the consumer is provided additional weight based on the amount of active user participation involved in the action. An action that shows a high level of engagement, such as viewing a ratings page for an agent, will be weighted higher than a less engaged action such as simply viewing a property listing page. Each action may have a corresponding predefined second value that is set according to the level of engagement of that action. For example, the action of viewing driving directions for a property may have a corresponding second value of 5, and the action of requesting additional information about a property may have a corresponding second value of 20.

At operation 920, the lead scoring module 402 aggregates (e.g., sums) the respective overall weighting for each action to calculate the engagement score of the consumer. In some embodiments, the engagement score may be used to place leads into a course granular engagement level such as high, moderate, or low level of engagement.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Machine Architecture and Machine-Readable Medium

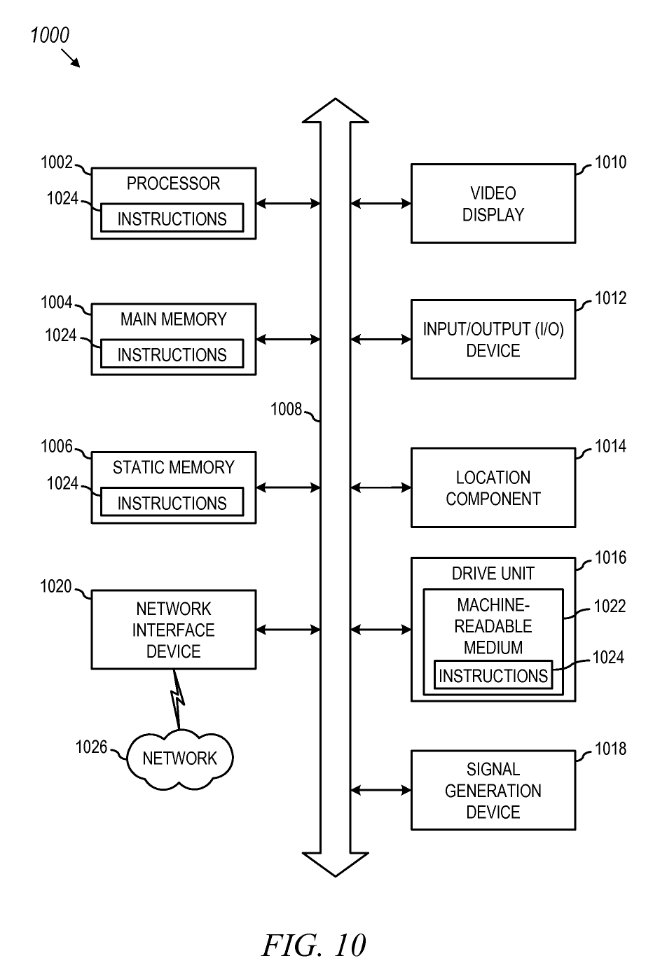

FIG. 10 is a block diagram of a machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Consistent with some embodiments, the computer system 1000 may correspond to the client device 210 and 212, the third party server 248 or any of the servers 216-238.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes one or more input/output (I/O) devices 1012, a location component 1014 (e.g., a GPS device), a disk drive unit 1016, a signal generation device 1018 (e.g., a speaker) and a network interface device 1020. The one or more I/O devices 1012 may, for example, include a keyboard, a mouse, a keypad, a multi-touch surface (e.g., a touchscreen or track pad), a microphone, a camera, or the like.

The location component 1014 may be used for determining a location of the computer system 1000. In some embodiments, the location component 1014 may correspond to a GPS transceiver that may make use of the network interface device 1020 to communicate GPS signals with a GPS satellite. Consistent with some embodiments, the location component 1014 may also be configured to determine a location of the computer system 1000 by using an internet protocol (IP) address lookup or by triangulating a position based on nearby mobile communications towers. The location component 1014 may be further configured to store a user-defined location in main memory 1004 or static memory 1006. In some embodiments, a mobile location enabled application may work in conjunction with the location component 1014 and the network interface device 1020 to transmit the location of the computer system 1000 to an application server or third party server 248 for the purpose of identifying the location of a user operating the computer system 1000.

In some embodiments, the network interface device 1020 may correspond to a transceiver and antenna. The transceiver may be configured to both transmit and receive cellular network signals, wireless data signals, or other types of signals via the antenna, depending on the nature of the computer system 1000.

### Machine-Readable Medium

The disk drive unit 1016 includes a machine-readable medium 1022 on which is stored one or more sets of instructions and data structures (e.g., software) 1024 embodying or used by any one or more of the methodologies or functions described herein. The instructions 1024 may also reside, completely or at least partially, within the main memory 1004, static memory 1006, and/or within the processor 1002 during execution thereof by the computer system 1000, the main memory 1004, static memory 1006 and the processor 1002 also constituting machine-readable media 1022.

Consistent with some embodiments, the instructions 1024 may relate to the operations of an operating system. Depending on the particular type of the computer system 1000, the OS may, for example, be the iOS® operating system, the Android® operating system, a BlackBerry® operating system, the Microsoft® Windows® Phone operating system, Symbian® OS, or webOS®. Further, the instructions 1024 may relate to operations performed by applications (commonly known as “apps”), consistent with some embodiments. One example of such an application is a mobile browser application that displays content, such as a web page or a user interface using a browser.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks 1026 include a LAN, a WAN, the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present invention has been described with reference to specific example embodiments, it will be evident that various modifications and changes may be made to these embodiments without departing from the broader scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

What is claimed is:

1. A method comprising:
determining a primary lead attribute of a lead, the lead being an individual with interest in conducting a real estate property transaction, the primary lead attribute being a characteristic of the individual;
identifying, using a processor of a machine, a real estate agent with expertise in conversion of leads having at least the primary lead attribute; and
allocating the lead to the real estate agent based in part on the expertise of the real estate agent in the conversion of leads with at least the primary lead attribute.

2. The method of claim 1, further comprising determining a secondary lead attribute of the lead, the secondary lead attribute being an additional characteristic of the individual that provides further information about the primary lead attribute.

3. The method of claim 2, wherein the expertise of the real estate agent is in conversion of leads having the primary and secondary lead attribute.

4. The method of claim 2, wherein the determining of the primary lead attribute comprises determining a lead type of the lead, and wherein the determining of the secondary lead attribute comprises determining a lead source of the lead.

5. The method of claim 4, wherein the lead source is a search query.

6. The method of claim 2, wherein the determining of the primary lead attribute comprises determining a user status of the lead on a network-based real estate service, and wherein the determining of the secondary lead attribute comprises determining an engagement score of the lead, the engagement score indicating the level of engagement of the lead with the network-based real estate service.

7. The method of claim 1, wherein the identifying of the real estate agent with expertise in conversion of leads having at least the primary lead attribute is based on a conversion rate of the real estate agent with respect to previous leads having at least the primary lead attribute.

8. The method of claim 1, wherein the identifying of the real estate agent with expertise in conversion of leads having at least the primary lead attribute is based on a total number of transactions closed by the real estate agent that involve leads having at least the primary lead attribute.

9. The method of claim 1, wherein the real estate agent is identified from a plurality of real estate agents assigned to a particular geographic area.

10. The method of claim 1, further comprising transmitting a notification to a client device of the real estate agent, the notification informing the real estate agent of the allocated lead.

11. The method of claim 1, further comprising determining that an engagement level of the lead is above a predefined threshold, wherein the determining of the primary attribute of the lead is in response to the determining that the engagement level of the lead is above the predefined threshold.

12. The method of claim 1, wherein the determining of the primary attribute of the lead is in response to receiving a request from a client device of the lead for a real estate agent.

13. A system comprising:
a processor of a machine;
an analysis module configured to determine a primary lead attribute of a lead, the lead being an individual with interest in conducting a real estate property transaction, the primary lead attribute being a characteristic of the individual;
an allocation module configured to identify, using the processor of the machine, a real estate agent with expertise in conversion of leads having at least the primary lead attribute, the processor-implemented allocation module further configured to allocate the lead to the real estate agent based in part on the expertise of the real estate agent in conversion of leads with at least the primary lead attribute.

14. The system of claim 13, wherein the processor-implemented analysis module is further configured to determine a secondary lead attribute of the lead based on the primary lead attribute, and wherein the real estate agent has expertise in conversion of leads with the secondary attribute.

15. The system of claim 14, wherein the primary lead attribute is a lead type of the lead, and wherein the secondary lead attribute is a lead source of the lead.

16. The method of claim 14, wherein the primary lead attribute is a user status of the lead on a network-based real estate service.

17. The method of claim 16, wherein the secondary lead attribute is a responsiveness level of the lead.

18. The method of claim 16, wherein the secondary lead attribute is an engagement level of the lead.

19. The system of claim 13, wherein the processor-implemented allocation module identifies the real estate agent with expertise in conversion of leads with at least the primary lead attribute by performing operations comprising:
accessing transaction history data of a plurality of real estate agents, the transaction history data representing real estate property transactions involving the plurality of real estate agents and clients of a real estate marketing platform, the plurality of real estate agents including the real estate agent;
identifying real estate property transactions involving prior leads with at least the primary lead attribute;
determining a conversion rate of each real estate agent of the plurality of real estate agent with respect to leads with at least the primary lead attribute; and
determining the real estate agent has expertise in conversion of leads with at least the primary attribute based on the conversion rate.

20. A non-transitory machine-readable storage medium embodying instructions that, when executed by at least one processor of a machine, cause the machine to perform operations comprising:
determining a primary lead attribute of a lead, the lead being an individual with interest in conducting a real estate property transaction, the primary lead attribute being a characteristic of the individual;
determining a secondary lead attribute of the lead based on the primary lead attribute;
identifying a real estate agent with expertise in conversion of leads having the secondary lead attribute; and
allocating the lead to the real estate agent based on the expertise of the real estate agent in conversion of leads having the secondary lead attribute.
